(19) United States
(12) Patent Application Publication
(10) Pub. No.: US 2008/0158762 A1
(43) Pub. Date: Jul. 3, 2008

(54) CIRCUIT BREAKER TRIP UNIT RATING SELECTION PLUG

(76) Inventors: Brian Patrick Lenhart, Louisville, KY (US); Nataniel Barbosa Vicente, Prospect, KY (US); Stephen James West, Louisville, KY (US); Todd Greenwood, Pewee Valley, KY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/617,952

(22) Filed: Dec. 29, 2006

(51) Int. Cl. H02H 3/087

(52) U.S. Cl. 361/93.2; 361/93.3; 700/292

(57) ABSTRACT

A rating plug that, in addition to setting the percentage de-rating on the voltage conditioning (i.e., gain/filter) circuit, by controlling the operational amplifier gain with analog switches in series with the opamp feedback loop, provides breaker frame and/or sensor information to a microprocessor.

### BACKGROUND OF THE INVENTION

The invention described herein relates to the field of circuit breakers, and more particularly, to the field of rating plugs for circuit breakers having electronic sensors or trip units. An electronic trip unit (“ETU”) is a device that is used in conjunction with an electro-mechanical circuit breaker to control the current (and or voltage) verses time trip response. The time versus current trip characteristics are, in part, a function of the maximum continuous current permitted by the circuit breaker.

Circuit breakers are widely used to protect electrical lines and equipment. The circuit breaker monitors current through an electrical conductor and “trips” to open the electrical circuit and thus interrupt current flow through the circuit provided that certain predetermined criteria are met. The circuit breaker may, of course, also be used to monitor voltage, and trip in case of any disturbance in pre-set voltage conditions such as under-voltage, over-voltage, and voltage imbalance conditions. Such criteria include, for example, the maximum continuous current permitted in the protected circuit. This maximum continuous current the circuit breaker is designed to carry is known as the frame rating or current rating of the circuit breaker. As long as the current remains below any protection (long-time, short-time, ground fault, or instantaneous) rating, the breaker will remain closed. The time delay and generation of the trip signal is an inverse function of the magnitude of the current. For very large magnitude overcurrents, such as would be produced by a fault, the microcomputer is programmed to generate a trip signal instantaneously.

The modification of the current vs. trip time response curve is a serious matter. For safety purposes, the circuit breaker must be properly configured to provide the type of protection judged by the customer or plant engineer to be appropriate. Therefore the modification to this protection must also be considered to be a very serious event and handled in a way that prohibits errors.

Typically, the circuit breaker current rating is set by a rating resistor which can be a “burden resistor” located in series with the secondary current transfer current, or a resistor in the feedback loop of the gain circuit operation amplifier, or a combination of both. These are selected to generate a preset voltage when a current proportional to the maximum, continuous current permitted in the protected circuit passes through the rating resistor. In order to provide for adjustment of the current rating so that the circuit breaker can be used to protect circuits with different maximum continuous currents, it is known to incorporate the rating resistor in a replaceable rating plug that may be selectively inserted into the breaker. In addition, this rating resistor can be set in parallel or in series with the “burden” and feedback loop gain resistor.

Electronic trip circuit interrupters are designed to interrupt overcurrent conditions over a wide range of ampere ratings. The current through the protected electric power circuit is continuously sensed by means of current transformers and a voltage signal is supplied to the signal processor within the ETU circuit. This voltage is conditioned by the rating resistor in the rating plug. The size of the rating resistor accordingly sets the ampere rating of the corresponding circuit interrupter. A common electronic circuit interrupter could therefore operate over a wide range of ampere ratings by merely changing the value of the burden resistor within the electronic trip circuit. It is important to prevent an electronic circuit interrupter from being inserted within an electrical distribution circuit for which the circuit interrupter is over-rated. It is perhaps equally important not to insert a circuit interrupter within an electric power distribution circuit for which the circuit interrupter is under-rated, as so-called “nuisance-tripping” could occur. It is also important to insure that a circuit interrupter is not inserted within an electric power distribution circuit with no rating plug.

Thus, the rating of the circuit breaker trip unit is conventionally set by many methods such as, for example, by the conventional removal and replacement of a removable rating plug. In a majority of instances, the rating plug contains either a resistor that sets the gain for each individual phase or NMV (i.e., non volatile memory is memory that retains its data when power is turned off from the circuit) with a programmed rating value that is read by a microprocessor within the breaker during power up. However, such methods may not be fully acceptable for some applications.

Rating plugs for circuit breakers with electronic trip units are known in the art as discussed previously. The rating plug changes the operating curve for actuation of a breaker having an electronic circuit interrupter (trip unit), thus changing the ampere rating of the breaker. Not all rating plugs are compatible with all electronic trip units. Therefore, a known problem is to ensure that a rating plug is compatible with the electronic trip unit into which it is to be inserted.

For safety's sake, all electronic trip units with interchangeable rating plugs are required to reject incorrect combinations of rating plugs and trip units. Such rejection is typically accomplished by the placement of pins within the receptacle in the trip unit into which the rating plug is to be inserted. The pins, which are normally located on the sides of the trip unit housing, interfere with protrusions on the side of the rating plug housing. Thus, prevention of installing rating plugs that are not compatible with a specific circuit breaker is prevented by keying the rating plug housing and the rating plug receptacle thereby preventing incompatible rating plugs from being installed in the circuit breaker.

While workable, this prior art system has several drawbacks and disadvantages. One of these is that the interference between pins and protrusions does not occur until the rating plug is almost fully inserted into the trip unit, often resulting in the user mistakenly believing that insertion of the rating plug has been properly completed. Another problem is that the pins are independent elements, i.e., they are not part of the rating plug housing or the trip unit housing, and as such a pin may be removed by someone tampering with the unit, and the user will not know whether a pin should be present or not.

### BRIEF SUMMARY OF THE INVENTION

One aspect of the invention described herein is to a switch logic level rating plug that allows a single rating plug optioned at the time of manufacture to be used for all breaker frame and sensors.

Another aspect of the invention is to describe a rating plug that, in addition to setting the percentage de-rating on the voltage conditioning (i.e., gain/filter) circuit, by controlling the operational amplifier gain with analog switches in series with the opamp feedback loop, provides breaker frame and/or sensor information to the microprocessor (this capability being due to being a logic level signal input of 5 volts.

Still another aspect of the invention is to describe a rating plug that automatically sets the gain level on the voltage conditioning (gain/filter) circuit before the microprocessor power-up, thus allowing the breaker protection to be provide rapidly, and thus allowing for a faster trip time band and better coordination.

More specifically, regarding the invention described herein, the trip unit will have a rating plug that will contain a series of switches and a connector for affixing the plug to the trip unit. The switches, which will be programmed at the time of manufacture, will identify the breaker frame and/or the sensor rating and/or the de-rating factor allowing the breaker to be de-rated (i.e., a lowering of the effective current capability for example, from a 2000 ampere capability de-rated to 40% or a set of similar parameters). By utilizing this rating plug method, the phase gain is set immediately for protection and the microprocessor is able to read the switch settings for metering purposes. For example, if the ultimate user of a circuit breaker were to purchase and install a 2000 Ampere circuit breaker, and realize subsequently that the proper circuit breaker for the intended load should be 800 Ampere, instead of purchasing and installing a new circuit breaker for the intended load of 800 Amperes, they would merely remove and replace the existing rating plug to a 40% (i.e., 40% of 2000 is 800) de-rating plug.

A more thorough and complete understanding of the rating plug according to the present invention can be had by those skilled in the art by reference to the following figure and detailed description.

### DESCRIPTION OF THE DRAWINGS

FIG. 1 depicts the main components of the electronic trip unit according to the present invention; and

FIG. 2 depicts a more detailed view of the rating plug and gain/filter conditioning interface as generally indicated in FIG. 1 and above.

### DETAILED DESCRIPTION

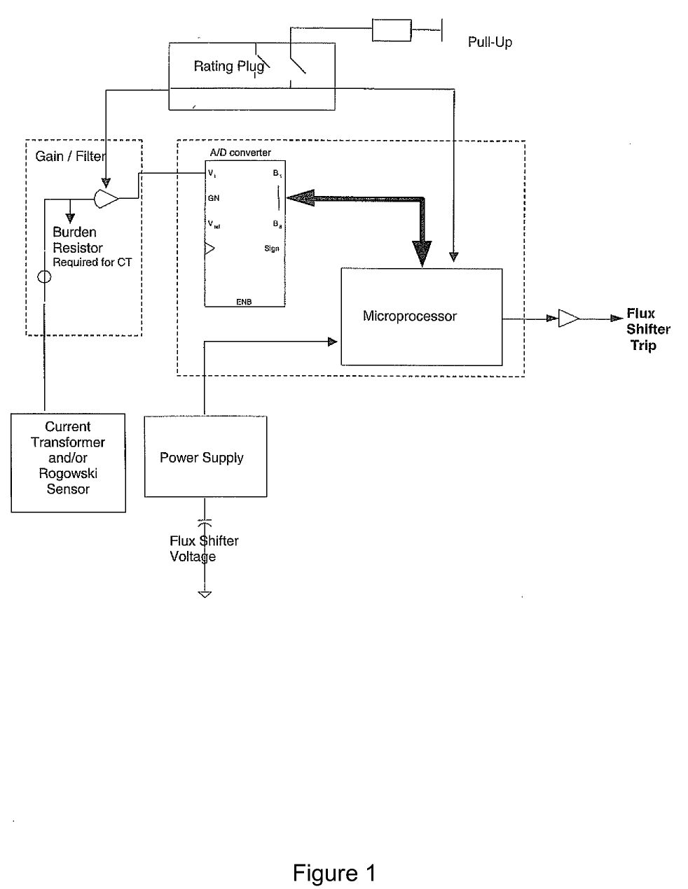

With reference to FIG. 1, The Current Transformer powering the main components of the electronic trip unit (“ETU”) provides an alternate secondary current output that is proportional to the primary current flowing through it. For example, if a 1000 A current is flowing through the primary coil of the transformer, a lesser current, as for example 200 mA will flow out of the transformer to the trip unit. The trip unit will use this secondary output for both power to operate and for sensing the current flow. If, of course, the trip unit uses a current transformer sensor, a burden resistor will be necessary to generate the voltage feeding into the Gain/Filter circuit (in FIG. 1, a general feed line directed towards such a burden resistor is depicted within the gain/filter circuitry).

Alternatively, a Rogowski sensor may be substituted in place of the current transformer for sensing to provide a derivative secondary voltage output that is proportional to the high level primary current flowing through it. The Rogowski sensor or coil is a device for measuring alternate current or high speed current pulses, and consists of a helical coil of wire with the lead from one end returning through the center of the coil to the other end resulting in both terminals being at the same end. The complete coil is then wrapped around the feed line whose current is to be measured and, since the voltage is proportional to the rate of change of current in the feed line, the output signal from the coil will be proportional to the current flow.

As further depicted in FIG. 1, voltage from the current transformer burden resistor or the Rogowski coil output is passed through a Gain/Filter circuitry. The Gain/Filter is designed to provide filtering to remove any spurious electric ‘noise’ from the signal; analog integration in the case of Rogowski coil input; and uses the rating plug selection (40% to 100% of the breaker) to set the operational amplifier (“op-amp”) gain within the circuit in order to get the same voltage value on the microprocessor analog/digital converter (“A/D”) at the breaker rating. The following example is given to more fully explain the relationship between the rating plug selection to set the op-amp gain:

### EXAMPLE 1

As an example to more clearly demonstrate the gain/filter circuitry shown in FIG. 1, assume the existence of a circuit breaker rated at 1000 A, and a rating plug rated at 100% of the breaker rating of 1000 A. By applying a current of 1000 A, the voltage following the A/D converter will be 2 volts. Now, assume that the user wishes to change the breaker rating by changing the rating plug to one rated at 40% rather than 100%. Effectively, the change will result in an equivalent 400 A breaker as it will now be rated at 40% of 1000 A. The current applied will now be 400 A, and the A/D output voltage will remain at 2 volts. Thus, if the breaker is rated for 1000 A (100%), 2 volts will be obtained when the rated current is applied; and if the breaker is rated at 400 A, 2 volts will still be obtained when the rated current (400 A) is applied. In each of these two instances, the circuit breaker will trip if the rated current is exceeded.

The trip unit will recognize if the rating plug is set for one or the other amperages (either 400 A or 1000 A in this example, but other de-rating percentages are possible) even if both ratings provide 2 volts on the microprocessor A/D. This is possible because metering is a relatively slow process that is not as critical as protection, i.e., tripping. For metering, the microprocessor reads the switches preprogrammed into the rating plug to determine what is the breaker reading.

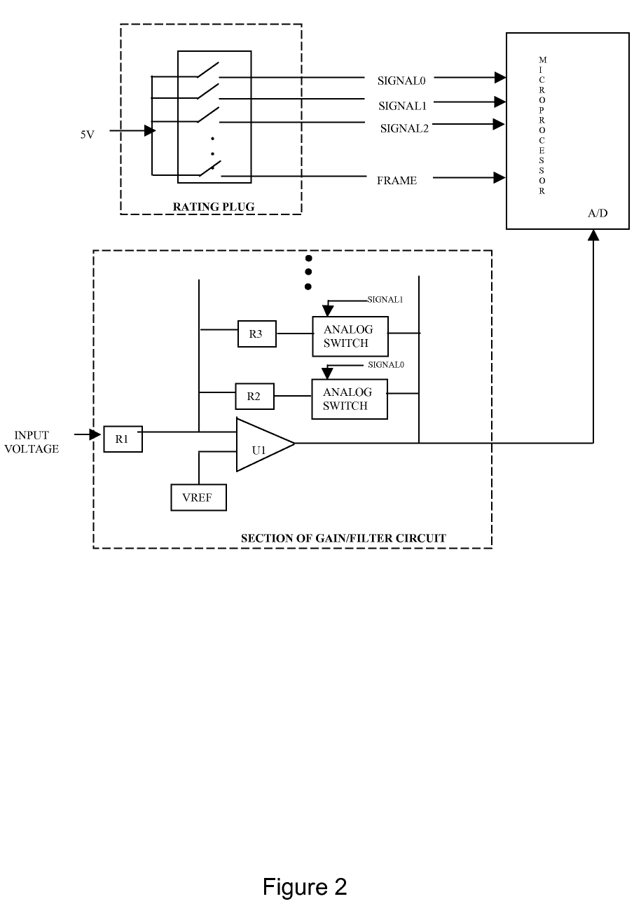

As depicted in FIG. 2, the rating plug is provided with a 5 volt input line to energize the plug which contains a series of switches that are used to select and identify percentages (40% and 100% being exemplified in Example 1, however, other percentages may be selected as depicted, for example, in Table 1) and/or sensor rating and/or frame and/or additional related breaker/trip unit functions. The information that the switches provide is fed as signals (signal0, signal1, signal2, and frame being depicted in FIG. 2) to the microprocessor, and the microprocessor uses this signal to determine the de-rating percentage which is used for metering purposes. The individual switch setting (signal0, signal1, signal2 . . . ) controls the analog switch on/off operation. By controlling the analog switch operation in this manner, a different gain can be set for each percentage de-rating as generally shown in Table 1. As discussed below, the rating plug switches are pre-set at the time of the plug's manufacture to indicate a specific percentage de-rating and/or sensor and/or frame ratings. The section of the gain/filter conditioning circuit interface depicted in FIG. 2 contains resistors (R1, R2, and R3), an operational amplifier (U1) in addition to analog switches that receive signals from the rating plug. The output of the gain/filter, as depicted in both FIGS. 1 and 2, is fed into an A/D converter.

The rating plug switches (0-7 or more in the instance shown) may, for example, be configured in accordance with the following Table 1 to provide for the specified de-rating percentages:

TABLE 1

| Switches | | | | | | Current | Switches | | | |
|---|---|---|---|---|---|---|---|---|---|---|
| 7 | 6 | 5 | 4 | 3 | Frame | Sensor | 2 | 1 | 0 | % Derating |
| 0 | 0 | 0 | 0 | 0 | Error | | 0 | 0 | 0 | Error/40% |
| 0 | 0 | 0 | 0 | 1 | 1 | 150 A | 0 | 0 | 1 | 100% |
| 0 | 0 | 0 | 1 | 0 | 1 | 200 A | 0 | 1 | 0 | 90% |
| . . . | | | | | . . . | . . . | 0 | 1 | 1 | 80% |
| 0 | 1 | 1 | 0 | 0 | 2 | 2000 A | 1 | 0 | 0 | 70% |
| . . . | | | | | . . . | . . . | 1 | 0 | 1 | 60% |
| 1 | 0 | 1 | 0 | 1 | 4 | 4000 A | 1 | 1 | 0 | 50% |
| | | | | | | | 1 | 1 | 1 | 40% |
| | | | | | | | | | | . . . |

The power supply shown in FIG. 1 is configured to provide 18-24 volts for operation of the flux shifter, op-amps, and other components requiring this voltage within the circuitry, as well as 5 volts to power the microprocessor and other components requiring this voltage within the circuitry.

The microprocessor used for the electronic trip unit is manufactured to have an internal A/D designed to process the analog signal from the current transformer and/or Rogowski coil unit. The microprocessor is also manufactured to contain a non-volatile memory for storing trip unit setpoints and options—parameters that cannot be lost during a power failure. The microprocessor is further configured to provide a trip signal when the current exceeds the preprogrammed threshold limit through the use of the flux shifter, an electromechanical device that contains a coil and lever which, when energized by a trip signal coming from the microprocessor, will cause the breaker to open or trip.

There are several advantages of the electronic trip unit described herein and not found in trip units known before the making of this invention. Among these advantages are, for example, the advantage that it allows for the logic level signal (at 5 volts) to control the gain/filter circuit gain while in the past it has been necessary to use a feedback resistor on the rating plug to set the gain (under this condition any rating plug connection problem due to correction or small misalignment will cause the gain to change which is highly undesirable as it will end up with a different value on the microprocessor A/D than the expected). Another advantage is that because it is a logic level signal, the microprocessor can read the percentage de-rating (or breaker rating) frame from the rating plug without any delay. Still another advantage over past technology is that while the rating plug has been used in combination with non-volatile memory where the de-rating is saved in the rating plug NVM (i.e., in this case the trip unit microprocessor needs to obtain a reading from the breaker rating from the rating plug non-volatile memory and then make trip decision base on this value; a very time consuming mechanism and one in which the breaker may not trip on time). However, in the present instance, as soon as the unit is powered up, the gain is automatically determined and set (even before the microprocessor powers-up), allowing the microprocessor to read the switch for metering purposes only.

Thus while we have illustrated and described the preferred embodiment of our invention, it is to be understood that this invention is capable of variation and modification, and we therefore do not wish to be limited to the precise terms set forth, but desire to avail ourselves of such changes and alterations which may be made for adapting the invention to various usages and conditions. Such variations and modifications, for example, would include the substitution of structurally similar components provided herein which function to yield substantially similar results to those specifically described above. Thus, those changes that do not substantially alter the function of the components or their uses specifically described above are deemed to be within the scope of the present invention. Accordingly, such changes and alterations are properly intended to be within the full range of equivalents, and therefore within the purview of the following claims.

Having thus described our invention and the manner and a process of making and using it in such full, clear, concise and exact terms so as to enable any person skilled in the art to which it pertains, or with which it is most nearly connected, to make and use the same.

What is claimed is:

1. A circuit breaker trip unit rating plug comprising means for affixing the plug to an trip unit; and a series of switches adapted to control analog switch on/off operation and to indicate a specific percentage de-rating and/or sensor and/or frame rating for said plug.

2. A circuit breaker trip unit rating plug according to claim 1 which further comprises means for providing a voltage to said plug to energize said plug, and means for an electrical signal from each switch in said series to be transferred from said plug to a microprocessor.

3. A circuit breaker trip unit rating plug according to claim 1 wherein the percentage de-rating of said plug is between 40% and 100%.

4. A circuit breaker trip unit rating plug according to claim 1 configured to automatically set the gain level on a voltage conditioning circuit by controlling an opamp gain within said circuit with at least one of said series of switches, said switch being configured to be in series with the feedback loop contained within said opamp.

5. A circuit breaker comprising:
i. a current transformer and/or Rogowski coil configured for providing a secondary output that is proportional to the primary current flowing it;
ii. a circuit breaker trip unit rating plug comprising means for affixing the plug to an trip unit, and a series of switches adapted to control analog switch on/off operation and to indicate a specific percentage de-rating and/or sensor and/or frame rating for said plug; and
iii. a microprocessor having:
a. an internal analog to digital converter designed to process the analog signal from the current transformer and/or Rogowski coil, and unit;
b. a non-volatile memory for storing trip unit set-points and options; and
c. being configured to provide a trip signal when the current through said breaker exceeds preprogrammed threshold limit.
